(19) United States
(12) Patent Application Publication
(10) Pub. No.: US 2007/0171470 A1
(43) Pub. Date: Jul. 26, 2007

(54) System, method, and program for image processing, and management server

(75) Inventors: Keiko Fujii, Kanagawa (JP); Takashi Araki, Kanagawa (JP)

Correspondence Address: Kyocera Technology Development;Intellectual Property Administration, Suite 400, 1855 Gateway Blvd., Concord, CA, 94520, US

(73) Assignee: Kyocera Mita Corporation, Osaka-shi (JP)

(21) Appl. No.: 11/655,434

(22) Filed: Jan. 19, 2007

(30) Foreign Application Priority Data
Jan. 24, 2006 (JP) JP2006-015382

(51) Int. Cl. G06F 3/12

(52) U.S. Cl. 358/1.15; 358/1.13

(57) ABSTRACT

A method, program product, and system to provide an image processing system which allows the user to utilize a function of an image processing device with operation through another image processing device without implementing a large scale of modification on the device. The image processing system includes a service use device, a service provision device, and a management server which are connected to a communication network. The system can include more than one service provision device. The service use device transmits to the management server a service request signal which corresponds to a service selected by the user and image data. The management server transmits to the service provision device a service execution command signal corresponding to the received service request signal and the image data. The service provision device processes the received image data according to the received service execution command signal.

### FILED OF THE INVENTION

The present invention relates to an image processing system, more particularly to an image processing system comprising an image processing device, such as a copier, a facsimile, a printer, and a scanner, and a MFP (Multifunction Peripheral or Multi-Functional Peripheral) comprehensively having multiple functions of the aforementioned devices, and a management server which controls such devices.

### BACKGROUND OF THE INVENTION

Conventionally, a copier, a facsimile device, a printer device, a scanner, and other image processing devices are installed at many corporations and companies, and the corporations and companies attempt to raise efficiency of managing businesses and office tasks by optimizing the use of the devices. Alternatively, by introducing a MFP which integrates these multiple functions as one device, further improvement of operation efficiency is expected.

However, since MFPs are costly, to replace all image processing devices with a MFP is not realistic. In reality, in most cases, conventional image processing devices with a single function and a MFP or MFPs are installed together for the user to use each device depending on a task.

Alternatively, due to advancement of communication technology in recent years, various systems to provide effective use of an image processing device of this kind by connecting the image processing device to a network, such as a local area network and the internet, have been proposed, as disclosed in Japanese Patent Application Laid-Open No. 2001-277669 (hereinafter “patent publication 1”) and Japanese Patent Application Laid-Open No. 2002-330254 (hereinafter “patent publication 2”).

For example, an image output control device and others disclosed in the patent publication 1 reduces load to be incurred by a single device in output. They also constitute an image processing system of load-distribution type which helps to improve processing rate. Upon selection of multiple output devices to perform distribution-output, the image output control device acquires information on an output medium of each device, and after determining existence of a common output medium, notifies the determination result to the user.

Alternatively, a facsimile device disclosed in the patent publication 2 can, by including a remote facsimile function and constituting a network with an data processing device, not only directly transmit a document and the like created with the data processing device to a facsimile device of a recipient, but also decrease device installation space through multiple-functionalization of the facsimile device.

An image output control device disclosed in the patent publication 1, however, in performing distribution-output, requires for a device whereon the user performs operation to have functions to display menus for distribution-output and to acquire output media information (paper size, media type, and so forth) of the distribution output device. As for a facsimile device disclosed in the patent publication 2, a remote facsimile function, a printer function, a scanner function, and many other functions are required in addition to a facsimile function.

In other words, the each technology introduced in the aforementioned documents requires a specific application and function to be installed on a device (service use device) regularly used by the user in order for the user to use a certain service. Such realization necessitates an introduction of MFPs and a major modification on an existing device.

For this reason, regardless of efficiency improvement and minimization of installation space, in reality the cost to utilize the technologies is still high and full incorporation of the technologies has remained difficult.

The present invention was proposed to address such issues the conventional art presents.

### SUMMARY OF THE INVENTION

An object of the present invention is to provide an image processing system, a management server, an image processing method, and an image processing program which enables the user, in using an image processing device without a specific function, by operating through the image processing device without applying a major modification thereon, to use functions that other image processing devices have.

In order to accomplish such object, an image processing system of the present invention according to an aspect of the present invention, the image processing system, comprises: a service use device which provides an image processing service corresponding to a provided function; a service provision device which has a function that the aforementioned service use device does not have and which provides an image processing service corresponding to the function; and a management server which controls the service use device and the service provision device. The service use device, the service provision device, and the management server are connected through a communication network, and a function that the service provision device has is used through operation on the service use device. The image processing system can include more than one service provision device therein.

The service use device comprises: an image data input means which reads in an image and loads image data of the image; a display unit which, based on a notification from the management server, displays a list of performable image processing services; a service configuration means which performs configuration of an image processing service corresponding to an input operation through menu selection and/or key input operation; and a service request transmission means which transmits a service request signal corresponding to an image processing service configured through menu selection and/or key input, and the image data to the management server.

The management server comprises: a storage means which stores in a database a list of image processing services that the service provision device can provide; a service extraction means which extracts from the database a list of image processing services available to the service use device; a service notification means which notifies the service use device of the extracted list of image processing services; a service request reception means which receives the service request signal and the image data from the service use device; and a service execution command transmission means which transmits a service execution command signal, which corresponds to the aforementioned service request signal, and the image data to a specific service provision device in the image processing system.

The service provision device comprises: a service execution command reception means which receives the service execution command signal and the image data from the management server; and an image processing means which performs image processing corresponding to the service execution command signal on the received image data and outputs the data.

In an image processing system of the present invention comprising such configurations, an image data read at a service use device is transmitted through a management server to a service provision device, and the service provision device performs a certain image processing on the image data.

Accordingly, the user can use functions with which an operating device is not equipped by utilizing another device connected to a network. For example, by transmitting image data read by a scanner device of a service use device through a management server to a facsimile device of a server provision unit, facsimile transmission can be processed from the facsimile device to a recipient.

Additionally, an image processing system of the present invention can be realized simply by configuring a management server and providing a certain transmission function for an image processing device. Therefore, multiple functions can be efficiently used without replacing existing devices or performing a large scale of modification thereon.

As seen, an image processing system of the present invention enables the user to utilize a function not equipped on his or her operating image processing device as though the device actually has the function. Furthermore, the image processing system can minimize the cost and offer a highly efficient service.

Additionally, in an image processing system of the present invention according to another aspect of the present invention, the database comprises a model performance table which stores performance data of the service use device and a service table which stores service data of the service provision device, and the service extraction means determines and extracts, based on the performance data and the service data, an image processing service which the service use device can use and the service provision device can provide.

Especially, the model performance table stores performance data including model ID, model name, model type, input specification, or output specification data of the service use device. The service table stores service data including service ID, service name, screen information file, input format, output format, or service execution data format data of the service provision device.

In this configuration, a management server stores in a database detailed specifications and performance data of a service use device and a service provision device, and a service available to the system is automatically extracted and notified.

Accordingly, the user will be spared from inconveniences of verifying specifications of a service use device and searching for an appropriate service provision device each time using a service. Therefore, the user can use a service simply by selecting a desirable service and inputting required configuration information data, thereby a more efficient and convenient image processing system can be provided.

Furthermore, an image processing system of the present invention, according to another aspect of the present invention, comprises an automatic registration means for the management server to acquire service data of the service provision device connected to the communication network by polling the service provision device and to store the service data to the service table.

Yet furthermore, in an image processing system of the present invention, the management server comprises in the database a service provider table which stores specific data including IP address, model ID, or service ID data of the service provision device. The automatic registration means acquires and stores the specific data of the service provision device connected to the communication network by polling the service provision device.

In this configuration of an image processing system of the present invention, a management server regularly monitors a status of a service provision device connected to a network, automatically acquires essential information data, and registers or updates the data.

Since registered content is regularly updated, the user can be always informed on available services. Moreover, the system restrains occurrence of a human registration error.

Accordingly, an image processing system of the present invention can provide a highly precise and stable service environment.

Alternatively, in an image processing system according to another aspect of the present invention, the management server comprises a panel display data creation means which creates list data in order for the list of image processing services notified by the service notification means to be displayed on the display unit of the service use device, according to the display unit thereof.

The service notification means notifies the service use device of a list of performable image processing services by transmitting the list data.

Also, the panel display data creation unit creates operation information data for operation information of a selected image processing service in order therefor to be displayed on the display unit of the service use device, according to the display unit thereof. The service notification means notifies the service use device of the operation information, and the display unit displays the operation information data, based on a notification from the management server.

In an image processing system of the present invention of such configurations, a list of available services and operation information on a selected service are appropriately displayed, according to a type of operation panel of a service use device.

Thus, a service use device can be used without a major modification, and the further cost cut can be achieved.

Additionally, the system allows the user to operate on an operation panel of a device of a daily basis, the user can easily configure the device through menu selection and/or key input even when using a new function not installed on the device.

Accordingly, the image processing system is easy for the user to use and introduction of or switch-over to the system can be smoothly implemented.

Moreover, in an image processing system of the present invention according to another aspect of the invention, the service provision device provides a color printing, a facsimile transmission/reception, a booklet printing, a staple processing, a document box, or a hole-punch processing service.

According to an image processing system of the present invention of such configuration, a variety of the output functions with which a service use device is not equipped can be utilized thorough the service use device.

For example, a copier of a service use device with only monochrome output capability can also perform a color copying service if a service provision device with color printing function (a color printer and the like) is registered on a same network.

Furthermore, a management server of the present invention, according to another aspect of the present invention, is the management server which is connected through a communication network to a service use device which provides an image processing service according to an equipped function, and an image provision device which has a function that the image use device does not have and provides an image processing service according to the function. The management server directs the service use device, through operation on the service use device, to use a function that the service provision devices has. More than one service provision device can be connected to the management server.

The management server comprises: a storage means that stores in a database an image processing service which the service provision device can provide; a service extraction means which extracts a list of image processing services available to the use device from the database; and a service notification means which notifies the service use device of the extracted list of image processing services. Furthermore, the management server can be configured to direct the service use device to display a list of performable image processing services and configure an image processing service to use, according to an input operation on the service use device through menu selection and/or key input operation, and direct a specific service provision device connected to the management server to perform the image processing service.

Alternatively, an image processing method of the present invention, according to anther aspect of the invention, is the image processing method in which a service use device which provides an image processing service corresponding to an equipped function and an image provision device which has a function that the service use device does not have and provides an image processing service corresponding to the function are connected through a communication network. The image processing method directs the service use device, through operation on the service use device, to use a function that the service provision device has. The method can include more than one service provision device.

The image processing method of the present invention comprises steps of: storing an image processing service that the service provision device can provide; extracting a list of image processing services available to the service use device; notifying the service use device of the extracted list of image processing services; directing the service use device to display a list of performable image processing services; directing the service use device to configure an image processing service to use, according to an input operation on the service use device through menu selection and/or key input operation; and directing a specific service provision device in the image processing method to perform the image processing service.

Accordingly, the present invention can be realized not only as an invention of a system comprising a plurality of the devices, but also as an invention of a single body device constituting a management server or a method.

Furthermore, an image processing program of the present invention, according to an aspect of the present invention, provides a computer system for the image processing system, the computer system, comprising: a service use device which provides an image processing service corresponding to an equipped function; a service provision device having a function that the service use device does not have, which provides an image processing service corresponding to the function; and a management server which controls the service use device and the service provision device. The service use device, the service provision device, and the management server are connected to each other through a communication network. Additionally, the computer system can include more than one service provision device.

The computer system is also for causing a computer constituting the service use device to function as: an image data input means which reads in an image and loads image data of the image; a service list display means which displays a list of performable image processing services, based on a notification from the management server;

a service configuration means which performs configuration of an image processing service to be used, according to an input operation through menu selection and/or key input operation;
and a service request transmission means which transmits to the management server a service request signal corresponding to the configured image processing service and the image data.

Furthermore, the computer system causes a computer constituting the management server to function as: a storage means which stores an image processing service the service provision device can provide; a service extraction means which extracts an image processing service available to the service use device; a service notification means which notifies the service use device of the extracted image processing service; a service request reception means which receives the service request signal and the image data from the service use device; and a service execution command transmission means which transmits a service execution command signal corresponding to the service request signal and the image data to a specific service provision device in the computer system.

Yet furthermore, the computer system causes a computer constituting the service provision device to function as: a service execution command reception means which receives the service execution command signal and the image data from the management server; and an image processing means which applies an image processing corresponding to the service execution command signal on the received image data to output the image data.

As seen, the present invention can be also realized as a program. The program can be installed not only on the server but also on the other data processing devices.

Accordingly, the present invention can provide an image processing system with excellent universality and scalability.

As described, an image processing system, a management server, an image processing method, and an image processing program enables the user to use various functions with which an image processing device that user regularly uses is not equipped, without implementing a major modification on the device, by operating on another image processing device or other image processing devices having the functions.

Accordingly, an image processing system of high efficiency, convenience, and user-friendliness can be provided at low cost.

These and other objects, features and advantages of the present invention are specifically set forth in or will become apparent from the following detailed descriptions of the invention when read in conjunction with the accompanying drawings.

### DESCRIPTION OF THE DRAWINGS

FIG. 1 is a system configuration diagram of an image processing system of a preferred embodiment of the present invention.

FIG. 2 is a configuration block diagram indicating configurations of each device of an image processing system of a preferred embodiment of the present invention.

FIGS. 3A, 3B, 3C are types of data tables stored in a database of a management server in an image processing system of a preferred embodiment of the present invention.

FIG. 4 is a sequence diagram indicating registration steps of a service provision device in an image processing system of a preferred embodiment of the present invention.

FIG. 5 is a sequence diagram indicating a first half of service execution (start-service list display) in an image processing system of a preferred embodiment of the present invention.

FIG. 6 is a sequence diagram indicating a latter half of service execution in an image processing system of a preferred embodiment of the present invention.

FIGS. 7A, 7B, 7C, and 7D are screen transition diagrams illustrating each screen displayed on an operation panel of a service use device in an image processing system of a preferred embodiment of the present invention.

FIG. 8 is a sequence diagram indicating a first half of service execution (start-service list display) in an image processing system of a preferred embodiment of the present invention.

FIG. 9 is a sequence diagram indicating a latter half of service execution (use service selection-service execution) in an image processing system of a preferred embodiment of the present invention.

FIG. 10 is another system configuration diagram of an image processing system of the present invention.

### DETAILED DESCRIPTION OF THE INVENTION

Exemplary embodiments of the present invention are explained below with reference to the accompanying drawings though these embodiments are not intended to limit the invention. Additionally, in some instances, well-known structures, interfaces, and processes have not been shown in detail in order not to unnecessarily obscure the present invention.

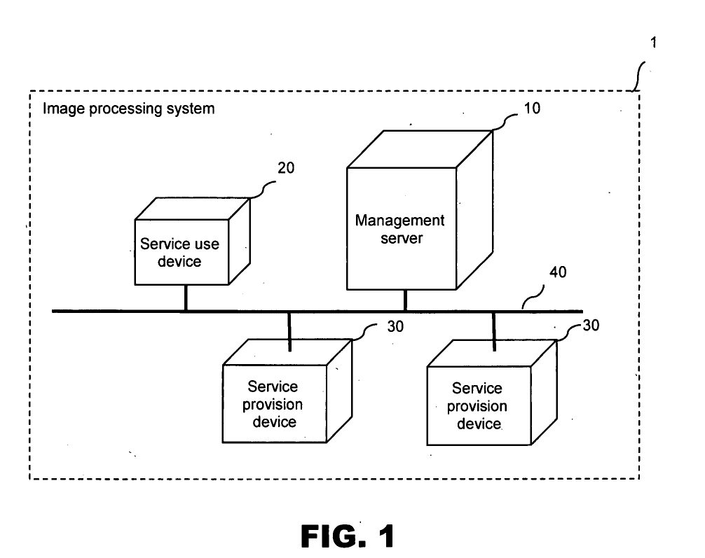

The following describes the preferred embodiments of the present invention with reference to FIGS. 1 through 10.

An image processing system of the preferred embodiments of the present invention described below is realized by processings, means, and functions executed on a computer, according to a command by the program (software). The program sends a command to each configuration element of the computer to make the each perform the following specific processings or functions. In other words, each processing and function in an image processing system of the preferred embodiments are realized through a concrete means in cooperation of the program and the computer.

Alternatively, the entire or a part of the program is provided with a magnet disk, an optic disk, a semiconductor memory, and other storage media which can be read at a computer. The program read from the storage medium is installed on the computer and executed. The program can also be directly loaded on the computer through a communication network without mediated through the storage medium to be executed.

FIG. 1 is a system configuration diagram of an image processing system of a first preferred embodiment of the present invention.

As illustrated in FIG. 1, an image processing system 1 of the first preferred embodiment comprises a management server 10, a service use device 20, a service provision device 30, and a service communication network 40 connecting them.

The image processing system 1 is a system which enables, when the service provision device 30 has a function that the service use device 20 does not have, the service use device 20 to use the function of the service provision device 30 through operation on the service use device 20.

The service use device 20 and the service provision device 30 of the first preferred embodiment include a copier, a printer, a scanner, a facsimile device, a MFP, and other image processing devices.

A common combination of the two devices is, for instance, the service use device 20 being a copier and the service provision unit 30 being a MFP. When the user uses a copier, conventionally, the user can only use the copier function installed on the copier. However, by connecting the copier with a MFP through a management server of the first preferred embodiment, the user can also use other functions of the MFP, such as a facsimile function.

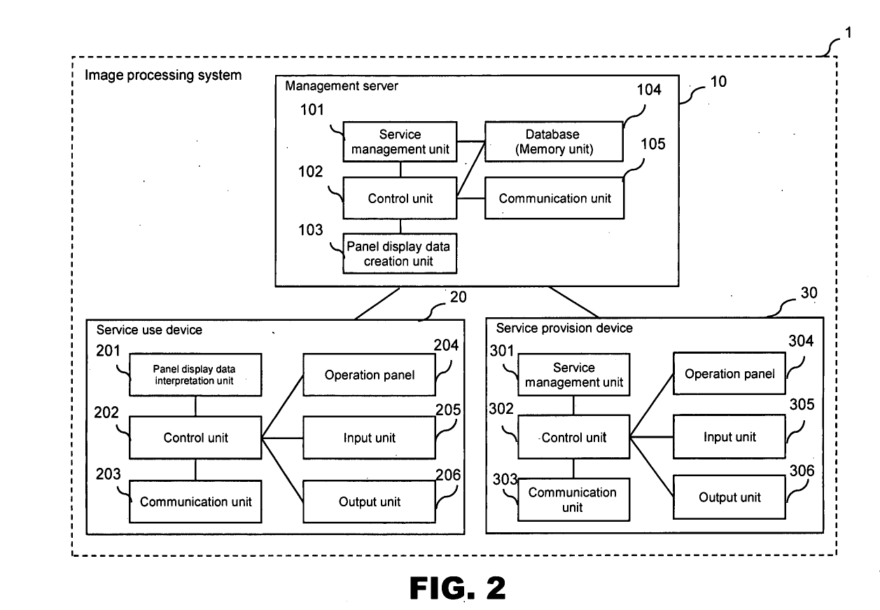

FIG. 2 is a configuration block diagram illustrating a configuration of each device in an image processing system of the first preferred embodiment of the present invention.

The following describes in detail each device which constitutes an image processing system of the first preferred embodiment of the present invention.

The management server 10 controls an entire image processing system. The management server 10 mainly relays data sent and received between the service use device 20 and the service provision device 30, and performs input/output of a relating control signal.

As illustrated in FIG. 2, the management server 10 comprises a service management unit 101, a panel display data creation unit 103, a database (memory unit) 104, and a communication unit 105.

The service management unit 101 registers and controls the service provision device 30. More specifically, the service management unit 101 registers to the database a name and an ID of a service which the service provision device 30 can provide, as well as a screen information file, an input format, an output format, a service execution data format, and other data of the service provision device 30.

A service name and a service ID are for identification and recognition of a type of providable service, and used for data search and notification.

A screen information file is a file which includes therein methods of a screen composition, a screen transition, and interpretation of panel input data. Additionally, image data used as panel display data, which is transmitted to the service use device 20, as well as data for various panel types are included in the file.

An input format is a format which indicates a format of input image data that the service provision device 30 can process at a time of service execution, and more specifically, which designates a file type, a color, and a resolution.

An output format is a format which indicates a format of image data that the service use device 20 receives and process after service execution. For instance, the format designates a file type that the service use device 20 can output.

A service execution data format is data which presents a type of service execution data. Depending on a service to be executed, the data format to be saved will differ.

For instance, for a facsimile transmission service, a facsimile number of a recipient and the like correspond to the service execution data format. Likewise, for a document box service, a folder name wherein data is saved and the like indicate the format. Such data configured at the service use device 20 is temporarily saved and used at a time of service execution.

Registration of the service provision device 30 can be automatically performed. More specifically, the management server 10 regularly polls all devices connected to the communication network 40 and compares data extracted from the devices and a service provider table having been stored in advance in the database. When the service provision device 30 of new connection is detected, data of the service provision device 30 will be newly registered, and when data content is modified or altered, the data will be updated.

Accordingly, the service management unit 101 systematically performs registration and management of the service provision device 30.

A control unit 102 comprises a CPU (Central Processing Unit) having a microprocessor and others, and performs a plurality of controls on each unit constituting the management server.

For example, based on a request from the service use device 20, the control unit 102 performs an output command to a certain service provision device 30 among others when there is more than one service provision device 30, instructs the panel display data creation unit 103 to create panel display data to be displayed on the service use device 20, and performs others.

The panel display data creation unit 103 creates each type of panel display data corresponding to a panel type of an operation panel 204 of the service use device 20.

As a method for creating panel display data, a panel type of the service use device 20 is first extracted from a model performance table of the database, and screen information (screen composition, screen transition, and others) according to the extracted panel type is acquired from the screen information file. Panel display data is then created based on the acquired screen information.

Accordingly, the panel display data creation 103 creates display data in accordance with a panel type of the service use device 20. Therefore, any particular modification and other adjustments on a service use device for display data is unnecessary, thereby implementation cost will be kept low.

The database 104 is for storing each type of data necessary for using or providing a service, which is stored in a storage device and a storage media such as a hard disk (referred to as “storage means” or “memory unit”).

More specifically, the database 104 comprises a model performance table for the service use device 20 and a service table and the service provider table for the service provision device 30, and the each table stores essential data.

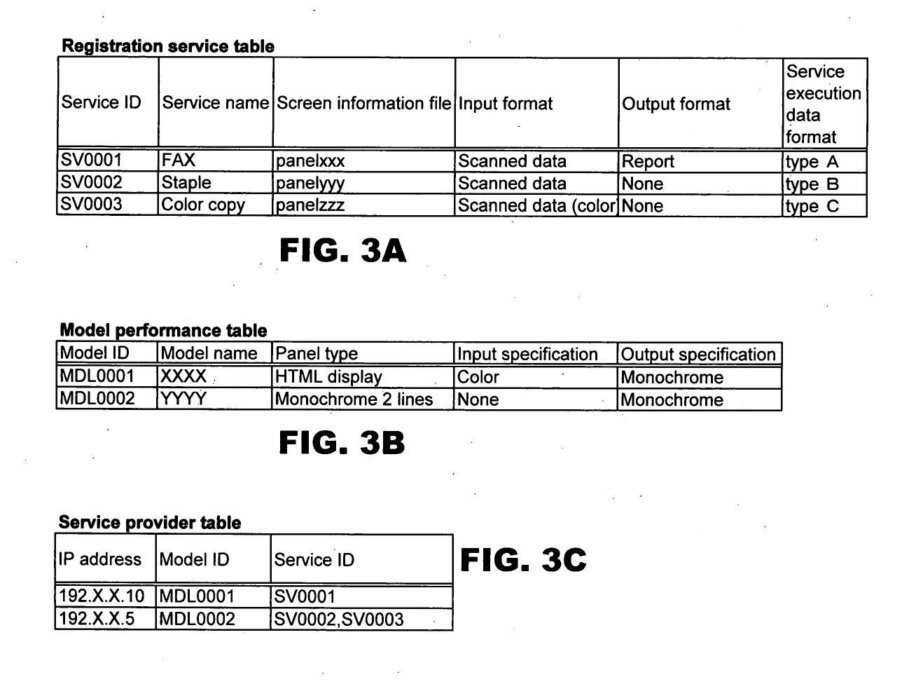

For instance, the model performance table stores data which indicate a model ID, a model name, a panel type, input specifications, output specifications, and others of the service use device 20 (see FIG. 3A).

Alternatively, the service table stores data which indicates a service ID, a service name, a screen information file, an input format, an output format, and others that the service provision device 30 can provide (see FIG. 3B).

Yet alternatively, the service provider table stores data which indicates an IP address, a model ID, a service ID, and others of the service provision device 30 (see FIG. 3C).

The communication unit 105 is responsible for communication between the service use device 20 and the service provision device 30 and is an interface which performs transmission and reception of certain signals and data.

As seen, the management server 10 accomplishes provision and use of each service through handling each type of control signals and data.

The service use device 20 of the first preferred embodiment of the present invention comprises an image processing device, particularly an image processing device having a single function such as a copier only with a copy function, and a printer device only with a printer function.

As illustrated in FIG. 2, the service use device 20 comprises a panel display data interpretation unit 201, a control unit 202, a communication unit 203, the operation panel 204, an input unit 205, and an output unit 206.

The panel display data interpretation unit 201 interprets data created at the management server 10 to display the data on the operation panel 204.

The control unit 202 comprises a CPU having a microprocessor and others, and performs various controls on each unit constituting the service use device 20. For example, the control unit 202 controls transmission of a service request signal corresponding to configuration of a service through menu selection and/or key input and image data.

The communication unit 203 performs communication with the management server 10 and is an input/output interface for each signal and data.

The operation panel 204 generally comprises a liquid crystal display and the like. The panel is of a touch panel configuration which allows the user to touch or push a displayed button to configure each service, input data, and perform other operations.

The input unit 205 reads a certain image of the user, converts the image into image data, and loads the data.

The output unit 206 prints out and performs others on image data loaded at the input unit 205 and received through the communication unit 203.

Similar to the service use device 20, the service provision device 30 of the first preferred embodiment comprises an image processing device. The service provision unit 30 becomes most useful when it has a function that the service use device 20 does not have. A common example of a service provision device is a MFP having a copier, printer, scanner, and facsimile function, among others.

As illustrated in FIG. 2, the service provision device 30 comprises a service management unit 301, a control unit 302, a communication unit 303, an operation panel 304, an input unit 305, and an output unit 306.

The service management unit 301 manages a service which the service provision device 30 can provide. For example, the service management unit 301 responses to an inquiry on capability of executing a service.

The control unit 302 comprises a CPU having a microprocessor and others, and performs various controls on each unit constituting the service provision device 30. More specifically, the control unit 302 instructs transmission of service data required at a time of service registration and performs a control on an execution of a service based on a command by the management server 10, and others.

The communication unit 303 performs communication with the management server 10 and is an input/output interface for each signal and data.

The input unit 305 and the output unit 306 are responsible for executing each service. A service executed by the input unit 305 is, for example, a facsimile reception service. Services executed by the output unit 306 are, for instance, a facsimile transmission, a color copy, a hole-punch processing, a staple processing, and other services.

Additionally, the user can verify a status of an executing service, if he or she wishes, by displaying the status thereof on the operation panel 304.

As described, the image processing system 1 of the first preferred embodiment is realized through cooperation of each of the devices having the management server 10 as a hub. More specifically, the image processing system 1 provides a system which makes a function of an image processing device (the service provision device 30) available to another image processing device (the service use device 20) regularly used by the user, through operation on the image processing device of the.

The following describes processing sequences in an image processing system of the first preferred embodiment configured as above-described.

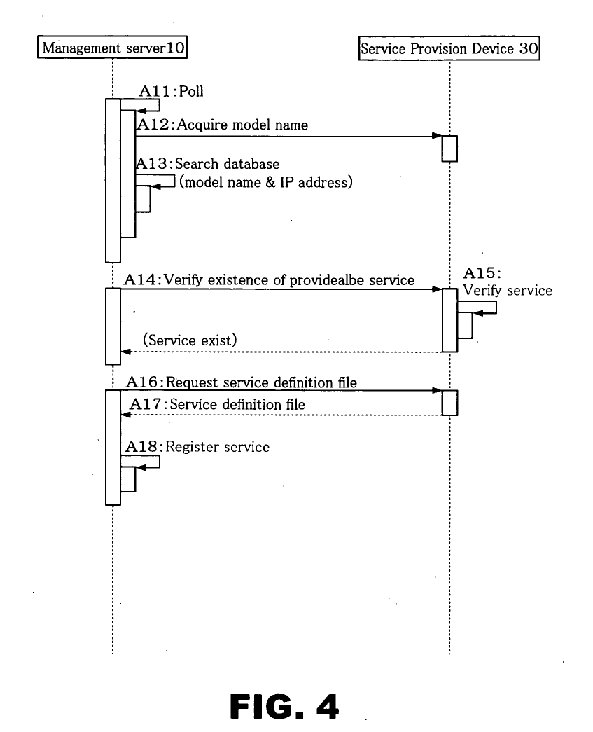

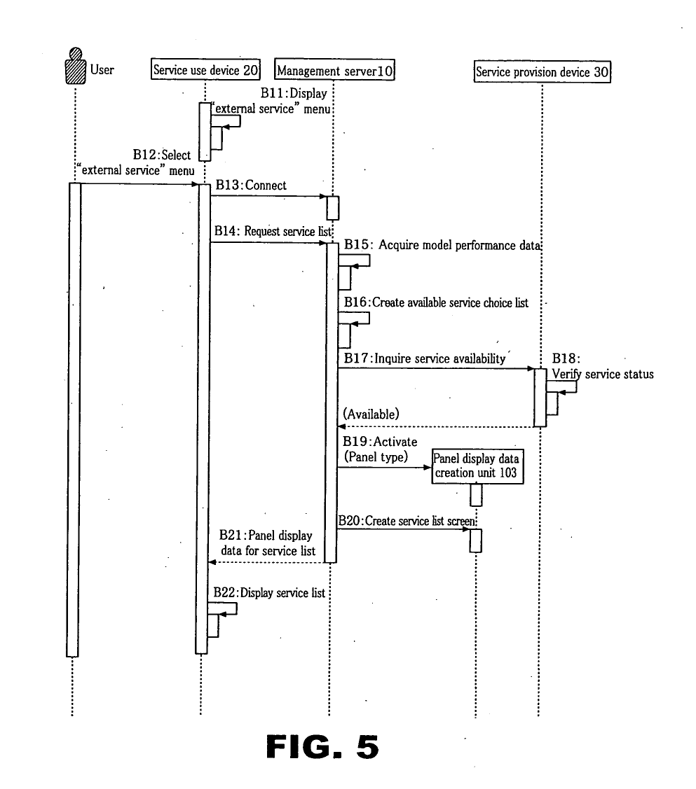

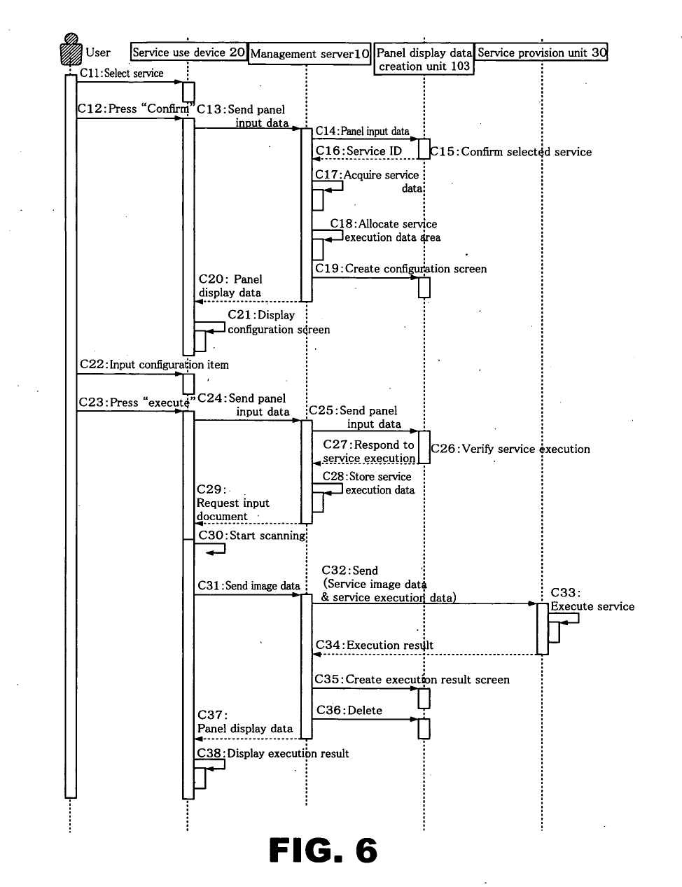

FIG. 4 is a sequence diagram illustrating registration steps of a service provision device of the first preferred embodiment. FIGS. 5 and 6 are sequence diagrams illustrating service execution steps.

The following describes registration steps of the service provision device 30 with reference to FIG. 4.

The management server 10 regularly performs poll processing on image processing devices connected to the communication network 40 (step A11).

Acquiring a model name and other data of the image processing devices through the poll processing helps identifying existing image processing devices (step A12).

The management server 10 searches the database 104 (the service provider table), under IP addresses and model names of detected image processing devices, to verify whether the image processing devices have already been registered (step A13).

When a detected image processing device is not registered to the database 104, the management server 10 recognizes the detected image processing device as the service provision device 30 to be newly registered.

On the other hand, when the device has already been registered, registration operation may immediately be terminated. Alternatively, when modification is identified upon verification of the other related data (provision service ID and the like), it is also possible to update the data.

Next, the management server 10 checks the service provision device 30 on existence of a service which the service provision device 30 can provide (step A14).

The service provision device 30 having received a verification request from the management server 10 verifies existence of the service to provide (step A15).

When there are one or more providable services, if provision of the service(s) is(are) not particularly restricted, the service provision device 30 returns a permission signal to indicate existence of a providable service.

Meanwhile, when there is(are) no providable service(s), or some restrictions apply on provision the service(s), the service provision device 30 returns a rejection signal to indicate inexistence of a providable service. Upon reception of the rejection signal by the management server 10, the registration of the service provision device 30 is cancelled and terminated.

The management server 10 having received the permission signal from the service provision device 30 then requests the service provision device 30 for data (a service definition file) necessary for service data registration (step A16) and acquires the data (step A17).

The service definition file is data comprising a provision service name, an input/output format, a service execution data format, operation screen information, and so forth.

The management server 10 interprets the acquired service definition file and registers the necessary data to the database 104 (the service table and the service provider table) (step A18).

Through these sequence steps, the automatic registration means of the service provision device 30 is executed.

The following describes service execution steps with reference to FIGS. 5, 6, 7A, 7B, 7C, and 7D.

FIG. 5 illustrates a first half of service execution process (start-service list display).

FIG. 6 is a sequence diagram illustrating a latter half of service execution process (service selection-service execution).

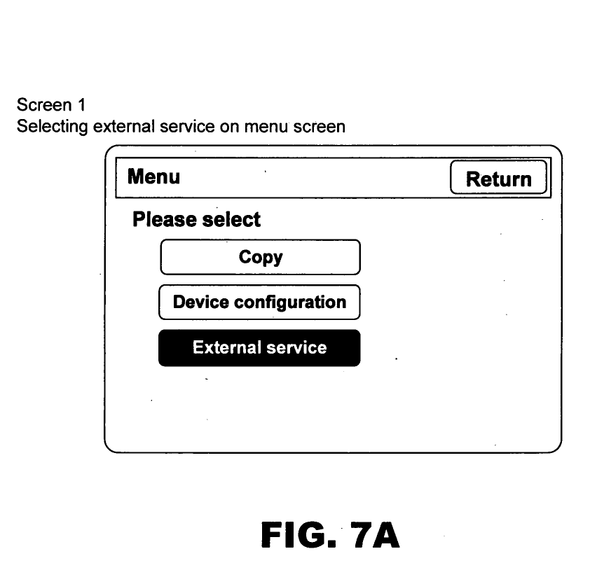

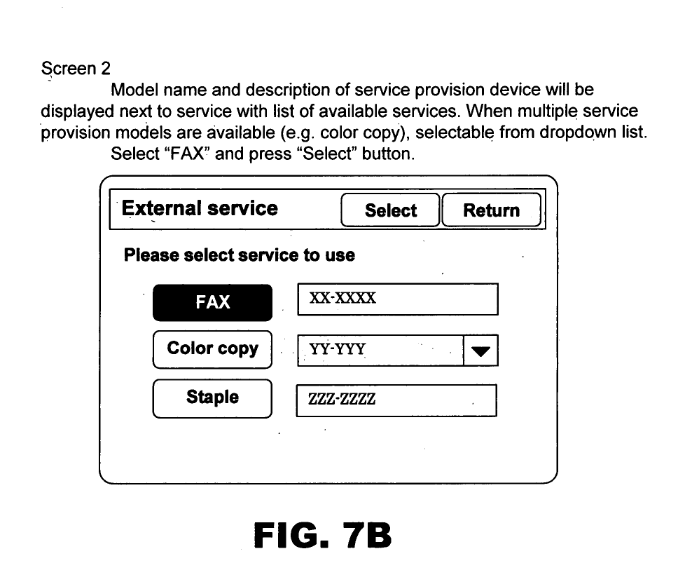

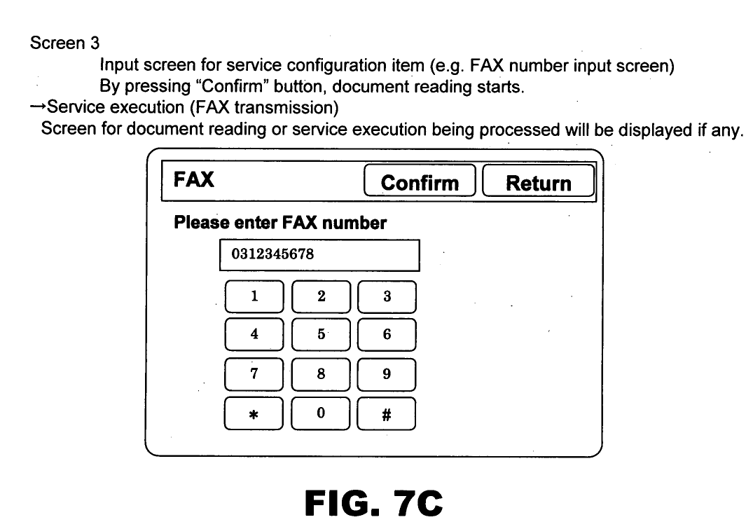

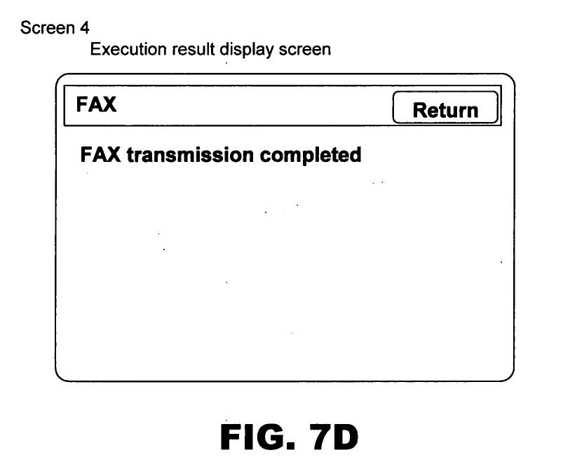

Alternatively, FIGS. 7A, 7B, 7C, and 7D are screen transition diagrams indicating each screen to be displayed on the operation panel 204 of the service use device 20.

As shown in the FIGS. 5 and 7A, an operation panel of a device (the service use device 20) that the user operates is displayed with an “external service” menu in a main service menu (step B11) to show that an external service is available to the image processing system 1.

Upon service use, the user selects the “external service” menu (step B12). As a response to the selection, the service use device 20 connects itself to the management server 10 (step B13).

Upon connection to the management server 10, the service use device 20 notifies the management server 10 of a model name of the service use device 20 and requests for a list of services which can be provided and are currently registered (step B14).

The management server 10 searches the database 104 (the model performance table) under the notified model name and acquires performance data including a panel type and input/output specifications (the scan color, the output file format, the file accessibility, and so forth) of the service use device 20 (step B15).

Next, the management server 10 creates a service choice list of available services (step B16). More specifically, the management server 10 acquires each type of registered service data (the input format, the output format, and the like) from the database 104 (the service table). Then, the management server 10 determines services available to the service use device 20 based on the service data and the performance data acquired at step B15, and list up all of them.

The service choice list is created based on service IDs.

For example, when a service the user desires to use is color-copying, the input format of the service data is indicated by “scanned data (color).” Additionally, when the input specifications of performance data are indicated by “color,” the service is determined as available for use and will be listed up.

When a service the user desires to use is facsimile transmission, the input format of the service data is indicated by “scanned data.” Also, when the input specifications of performance data are indicated by “color” or “monochrome” and if the service use device has a character input function, the service is determined as available for use and will be listed up.

The management server 10 then inquires the service provision device 30 on availability of a service listed on the service choice list (step B17). More specifically, the management server 10 first searches the database 104 (the service provider table) under the service ID for each service listed on the service choice list and specifies the service provision device 30 which is to provide the service when there is more than one service provision device 30. Then, upon notification of a service ID of the specified service provision device 30, the management server 10 inquires the service provision device 30 on availability of the service.

The service provision device 30 having received the inquiry from the management server 10 verifies a status of the service (available, unavailable, rejection, and the like) (step B18) and transmits a signal which indicates availability, unavailability, or rejection of the service to the management server 10. When the management server 10 receives a response of unavailability or rejection of the service, the service ID will be deleted from the service choice list.

The management server 10 having received a permission signal for a service activates the panel display data creation unit 103 and provides the panel type of the service use device 20 as initialized data for the panel display data creation unit 103 (step B19).

Next, based on the panel type, the management server 10 creates panel display data which indicates a list of providable services (step B20).

Specifically, the management server 10 first searches the database 104, under the service ID verified to be available at step B18, and extracts a corresponding service name and information of the corresponding service provision device 30. Then, by modifying the extracted information data according to the panel type, necessary panel display data is created. The panel display data created through this process is transmitted to the service use device 20 (step B21). The service use device 20 having received the data, then, displays the list of providable services on the operation panel 204 (step B22).

The following describes the latter half of service execution process (service selection-service execution) with reference to FIG. 6.

First, the user selects a choice of service from the list of services displayed on the operation panel 204 (step C11) and confirms the selection (step C12). For instance, as illustrated in FIG. 7B, when “FAX,” “color copy,” and “staple” are displayed as a list of services, if “FAX” is the user's choice of service, the user selects “FAX.”

Next, the service use device 20 transmits panel input data corresponding to a selection (e.g. “color copy”) to the management server 10 (step C13).

After receiving the panel input data, the management server 10 sends the data to the panel display data creation unit 103 (step C14), and based on interpretation of the panel input data, confirms the service selected by the user (step C15).

When there are a plurality of the service provision devices 30 which can provide the selected service, both the following configurations are acceptable: to create panel display data for an operation screen which allows the user to select a device and for the user to select one; or for the management server 10 to automatically select one based on a priority order of the device.

When the selected service is confirmed, the service ID of the selected service is transmitted to the management server 10 (step C16).

The management server 10 searches the database 104 under the service ID thereof to acquire service data (an input format, an output format, a screen information file name, and a service execution data format) (step C17).

Then, the management server 10 allocates an area for service execution data for storing information data input by the user and one on the service use device 20 (step C18).

Furthermore, the management server 10 creates at the panel display data creation unit 103 panel display data which indicates an input operation screen for configuration items (step C19).

Additionally, the management server 10 transmits the created panel display data to the service use device 20 (step C20).

The service use device 20 outputs the received panel display data to the operation panel 204, and thereby the input operation screen for configuration items is displayed (step C21).

Next, the user inputs required configuration items according to the display on the operation panel 204 (step C22) to confirm the inputs (step C23). For example, as illustrated in FIG. 7C, for a facsimile transmission, input a recipient's facsimile number and push the execution button.

The service use device 20 then transmits the panel input data (the configuration items) to the management server 10 (step C24).

The management server 10 having received the panel input data sends it to the panel display data creation unit 103 (step C25), and based on interpretation of the panel display data, verifies execution of the service by the user (step C26).

Once the service execution by the user is verified, the panel display data creation unit 103 returns a specific response signal to the management server 10 (step C27).

Upon reception of the signal, the management server 10 writes the configuration items on the service execution data and stores it (step C28).

Next, the management server 10 requests the service use device 20 that it transmit input image data, such as scanned data (step C29). At this time, a designated format for the input image data, for example, a file format and a reading resolution, is also transmitted together.

When executing a service which does not require input image data, the request in step C29 will not be performed. Instead, operation proceeds to step C32 to transmit to the service provision device 30 a service ID and service execution data of the service to be executed.

Some examples of this case will be to use image data stored in a storage device installed on the service provision device 30 and for the management server 10 to externally acquire and use the image data.

Upon reception of the request from the management server 10, the service use device 20 reads in an image (step C30).

The service use device 20 then creates image data based on the format designated in step C29 and transmits the image data to the management server 10 (step C31).

The management server 10 transmits the service ID, the image data, and the service execution data of the service to be executed to the service provision device 30 and instructs the service provision device 30 to execute the service (step C32). To note, service execution data can include performance data of a service use device.

Alternatively, for a service performing an output to the service use device 20; for example, outputting facsimile data received by the service provision device 30 to the service use device 20, the management server 10 receives image data sent from the service provision device 30, and the management server 10 transmits the data to the service use device 20 and instructs the service provision device 30 to execute the service.

Then, the service provision device 30 executes the designated service (step C33).

Upon completion of the service execution, the service provision device 30 notifies the management server 10 of a result of the execution (step C34).

The management server 10 creates at the panel display data creation unit 103 panel display data which indicates the execution result (step C35).

Once panel display data for the execution result is created, the service execution data which has been stored is deleted (step C36), and the panel display data of the execution result is transmitted to the service use device 20 (step C37).

At the service use device 20 having received the data, the execution result is displayed on the operation panel 204 (step C38).

For example, for a facsimile transmission service, the result will be displayed as illustrated in FIG. 7D.

As above-described, in the image processing system 1 of the first preferred embodiment of the present invention, image data loaded from the service use device 20 is transmitted through the management server 10 to the service provision device 30 and a certain image processing is performed on the data.

Accordingly, the user can use functions with which an image processing device he or she is operating is not equipped by utilizing another image processing device connected to a network.

Additionally, installation of the management server 10 having a specific function and provision of a certain communication function for an existing image processing device will be sufficient for realizing the first preferred embodiment of the present invention.

Thus, replacement of an existing image processing device and a large scale of modification are unnecessary, thereby an incursion of cost can be suppressed to a minimum.

Also, according to the image processing system 1 of the first preferred embodiment, the management server 10 stores detailed specification data and performance data of the service use device 20 and the service provision device 30 to the database 104.

Furthermore, the management server 10 verifies the data thereof and automatically extracts a providable service.

Accordingly, the first preferred embodiment will provide a convenient and efficient system.

Moreover, according to the image processing system 1 of the first preferred embodiment, the management server 10 regularly verifies and automatically registers a status of the service provision device 20 connected to a network.

Accordingly, a latest use environment is always provided for the user and the user can utilize services on a regular basis.

In the image processing system 1 of the first preferred embodiment, in order to appropriately display information of an available service and operation information of a selected service according to a type of the operation panel 204 of the individual service use device 20, the display data is created at the management server 10 (the panel display data creation unit 103).

This configuration allows the service use device 20 to use an existing image processing device and a display device thereof, and thereby helps to further suppress the implementation cost.

Additionally, utilization of an existing image processing device and a display device thereof makes it easier for the user to use the system, and therefore, the system introduction, too, can be smoothly achieved.

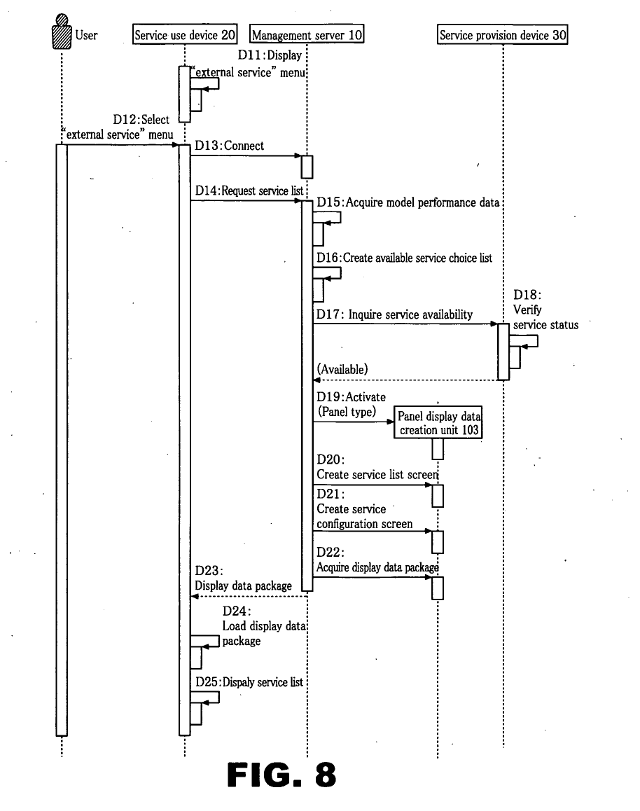

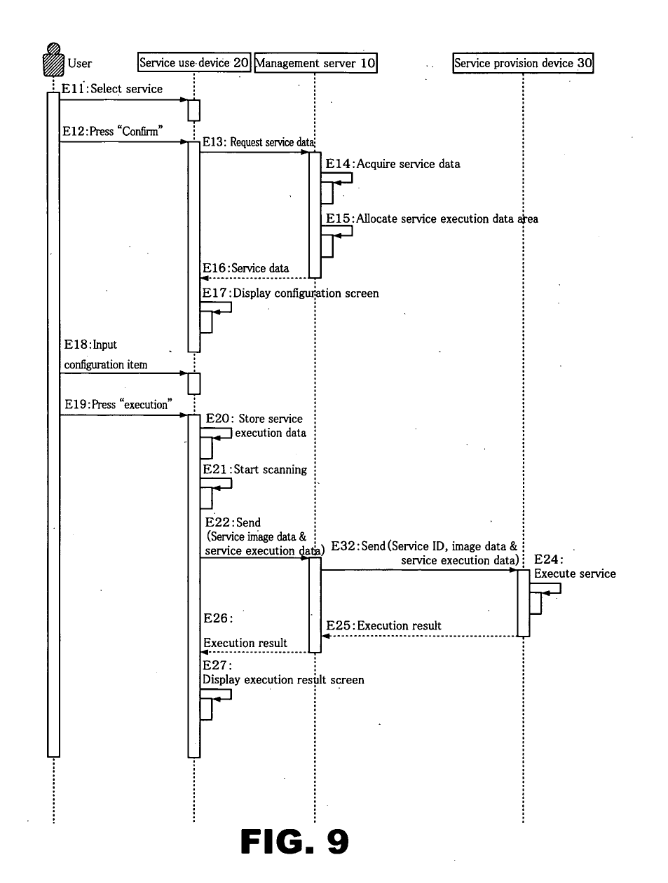

The following describes sequence steps of service execution on an image processing system of a second preferred embodiment of the present invention with reference to FIGS. 8 and 9.

FIG. 8 shows a first half of service execution process of an image processing system of the second preferred embodiment of the present invention (start-service list display). FIG. 9 shows a latter half of service execution process of the image processing system (service selection-service execution).

The second preferred embodiment of the present invention is a modified embodiment of the first preferred embodiment. It differs from the first preferred embodiment in that panel display data created at the management server is collectively transmitted to the service use device 20.

Configurations of the image processing system 1 and registration steps of the service provision device 30 in the second preferred embodiment are the same as those in the first preferred embodiment, and therefore, detailed descriptions on the configurations and the registration steps will be omitted herein.

Additionally, an identical part in the service execution steps will only be briefly described.

As illustrated in FIG. 8, the operation panel 204 of the service use device 20 will be displayed with an “external service” menu (step D11) to indicate that a service is available to the image processing system 1 of the second preferred embodiment.

For using a service, the user first select the “external service” menu (step D12), followed by the service use device 20 connecting itself to the management server 10 (step D13).

Upon connection to the management server 10, the service use device 20 notifies the management server 10 of a model name of the service use device 20 and requests the management server 10 for a list of services which can be provided and are currently registered (step D14).

The management server 10 searches the database 104 (the model performance table) under the notified model name, and acquires performance data, such as a panel type and input/output specifications (a scan color, an output file format, file accessibility, and so forth) of the service use device 20 (step D15).

The management server 10 then creates a choice list of available services (step D16).

Next, the management server 10 inquires the service provision device on availability of a service listed on the service choice list (step D17).

The service provision device 30 having received an inquiry from the management server 10 verifies a status of the service (available, unavailable, rejection, and the like) and respond to the management server 10 by sending a signal indicating availability or unavailability.

The management server 10 having received a service permission signal activates the panel display data creation unit 103 and provides the panel type of the service use device 20 as initialization data (step D19).

Next, the management server 10 creates at the panel display data creation unit 103 panel display data which indicates a list of providable services (step D20).

Then, the management server 10 creates at the panel display data creation unit 103 panel display data which indicates an input screen for configuration items (step D21).

The management server 10 packages the panel display data, the each created in step D20 and D21 (step D22), and transmits the packaged data to the service use device 20 (step D23).

The service use device 20 loads the received panel display data (step D24) and displays the list of providable services on the operation panel 204 (step D25).

Alternatively, the other set of loaded panel display data which indicates a configuration screen will be stored for later use.

The following describes the latter half of service execution steps (service selection-service execution) of the second preferred embodiments of the present invention with reference to FIG. 9.

First, the user selects a service of his or her choice from the list of services displayed on the operation panel 204 (step E11) and confirms the selection (step E12).

Next, the service use device 20 requests the management server 10 for service data of the selected service, based on the service ID thereof (step E13).

The management server 10 searches the database 104 under the service ID and acquires the service data (an input format, an output format, a screen information file name, and a service execution data format) (step E14).

The management server 10 allocates an area for service execution data for storing information data input by the user and one on the service use device 20 (step E15).

The management server 10 then transmits the service data acquired in step E14 to the service use device 20 (step E16).

Based on the service data received from the management server 10, the service use device 20 outputs the panel display data, which indicates a configuration screen, loaded in step D24 to the operation panel 204 to display an input operation screen for configuration items (step E17).

The user inputs necessary configuration items according to the display on the operation panel 204 (step E18) and confirms the input (step E19).

The service use device 20 then writes data of the input configuration items on the service execution data and stores the service execution data (step E20). While storing the data, the service use device 20 reads in an image (step E21).

Next, the service use device 20 transmits the read image data and the stored service execution data to the management server 10 (step E22).

Having received the data, the management server 10 transmits the service ID, the image data, and the service execution data of the service to be executed to the service provision device 30 and instructs the service provision device 30 to execute the service (step E23).

The service provision device 30 executes the designated service (step E24).

Once execution of the service is completed, the service provision device 30 notifies the management server 10 of a result of the execution (step E25). As a response to the reception of the notification, the management server 10 notifies the service use device 20 of the result of the execution (step E26).

Having received the execution result, the service use device 20 displays the execution result on the operation panel 204, according to the format of the panel display data, which had been loaded in advance (step E27).

As described, in the second preferred embodiment of the image processing system 1 of the present invention, the management server 10 collectively creates data for a list of services, configuration items, and execution result to be displayed on the service use device 20 and packages the data thereof to transmit to the service use device 20.

Therefore, not only does the second preferred embodiment achieve the equivalent result to that of the first preferred embodiment of the present invention, but the second preferred embodiment also involves fewer operation steps from the service start to the service execution completion to result in reduction of processing time.

Additionally, reduction of operation steps reduces load to be incurred on the management server 10, thereby stability of the system and energy reduction can also be achieved.

Although the invention has been described with respect to the preferred embodiments of the image processing system 1 of the present invention, the image processing system of the present invention is not to be thus limited but are to be construed as embodying all modifications and alternative constructions that may occur to one skilled in the art which fairly fall within the basic teaching herein set forth. There are changes that may be made without departing from the spirit and scope of the invention.

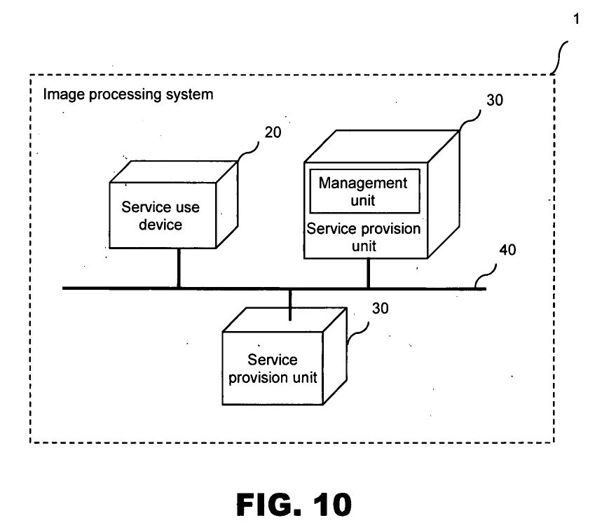

For example, as illustrated in FIG. 10, the management server 10 of the present invention can be embodied as the management unit in the service provision device 30.

Alternatively, the present invention can also control multiple service provision devices 30 for them to execute a service (distribution printing and the like) and to automatically execute a service when an error occurs on the service use device 20 (alternative printing and the like).

Furthermore, the database 104 constituting the management server 10 does not necessarily be embodied in the management server 10. For instance, the database 104 can be saved in an external storage device and others that are connected to the communication network 40 to be accessed to when needed.

The present invention will be best utilized in a system where a MFP with a plurality of functions and an image processing device without some of the functions the MFP has coexist.

The present document incorporates by reference the contents of Japanese priority document, Japanese Patent Application No. 2006-015382, filed in Japan on Jan. 24, 2006.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. An image processing system, comprising:
a service use device;
a management server; and
a service provision device; and
the service use device, further comprising:
a first service provision means which provides an image processing service according to an equipped function;
an image data input means which reads in an image and loads image data of the image;
a display unit which displays a list of performable image processing services, based on a notification from the management server;
a service configuration means which performs configuration of the image processing service, according to an input operation; and
a service request transmission means which transmits a service request signal according to the configured image processing service and the image data to the server;
the management server, further comprising:
a control means which controls the service use device and the service provision device;
a storage means which stores a list of image processing services that the service provision device can provide;
a service extraction means which extracts the list of image processing services available to the service use device;
a service notification means which notifies the service use device of the extracted list of image processing services;
a service request reception means which receives the service request signal and the image data from the service use device; and
a service execution command transmission means which transmits the service execution command signal corresponding to the service request signal and the image data to a specific service provision device in the image processing system; and
the service provision device, further comprising:
a second service provision means which is equipped with a function the service use device does not have and provides a service according to the function;
a service execution command reception means which receives from the management server the service execution command signal and the image data; and
an image processing means which applies an image processing corresponding to the service execution command signal on the received image data and outputs the data.

2. The image processing system of claim 1, further comprising:
a database which stores the list of image processing services that the service provision device can provide stored in the storage means and wherefrom the service extraction means extracts the list of image processing services available to the service use device.

3. The image processing system of claim 2, further comprising:
a model performance table which stores performance data of the service use device; and
a service table which stores service data of the service provision device, wherein:
the database has the model performance table and the service table, and
the service extraction means which, based on the performance data and the service data, determines and extracts an image processing service available to the service use device and the service provision device can provide.

4. The image processing system of claim 3, wherein:
the model performance table stores performance data which includes a model ID, a model name, a panel type, input specifications, or output specifications of the service use device; and
the service table stores service data which includes a service ID, a service name, a screen information file, an input format, an output format, or a service execution data format of the service provision device.

5. The image processing system of claim 3, further comprising:
an automatic registration means which acquires service data of the service provision device connected to a communication network by polling the service provision device and stores the service data thereof in the service table, wherein:
the management server has the automatic registration means.

6. The image processing system of claim 5, further comprising:
a service provider table which stores specific data including an IP address, a model ID, or a service ID of the service provision device in the database, wherein:
the management server has the service provider table; and
the automatic registration means acquires the specific data of the service provision device connected to the communication network by polling the service provision device and stores the data thereof.

7. The image processing system of claim 1, further comprising:
a panel display data creation unit which creates list data in order for the list of the image processing services notified by the service notification unit to be displayed, corresponding to the display unit of the service use device, wherein:
the management server has the panel display data creation unit; and
the service notification means transmits the list data to notify the service use device of the list of performable image processing services.

8. The image processing system of claim 7, wherein:
the panel display data creation unit creates operation information data for operation information of the selected image processing service in order for the operation information to be displayed corresponding to the display unit of the service use device;
the service notification means notifies the service use device of the operation information; and
the display unit displays the operation information data based on the notification from the management server.

9. The image processing system of claim 1, wherein:
the service provision device provides a color printing, a facsimile transmission/reception, a booklet printing, a staple processing, a document box, or a hole-punch processing service.

10. A management server connected through a communication network with a service use device which provides an image processing service corresponding to an equipped function, and a service provision device having a function that the service use device does not have, which provides an image processing service corresponding to the function, comprising:
a storage means which stores in a database an image processing service that the service provision device can provide;
a service extraction means which extracts from the database an image processing service available to the service use device;
a service notification means which notifies the service use device of the extracted image processing service;
a service request reception means which receives the service request signal and the image data from the service use device; and
a service execution command transmission means which transmits the service execution command signal corresponding to the service request signal and the image data to a specific service provision device in the image processing system.

11. An image processing method having a service use device which provides an image processing service corresponding to an equipped function, and a service provision device having a function that the service use device does not have, which provides an image processing service corresponding to the function, comprising the steps of:
storing an image processing service which the service provision device can provide;
extracting an image processing service available to the service use device;
notifying the service use device of the extracted image processing service;
directing the service use device to display a list of performable image processing services;
directing the service use device to configure, according to an input operation, an image processing service to use; and
directing a specific service provision device in the image processing method to execute the image processing service.

12. A storage medium having stored thereon a computer program executable, in a image processing system having a service use device which provides an image processing service corresponding to an equipped function, a service provision device having a function that the service use device does not have, which provides an image processing service corresponding to the function, and a management server which controls the service use device and the service provision device, for causing:
a computer constituting the service use device to function as:
an image input means which reads in an image and loads image data of the image;
a service list display means which displays a list of performable image processing services, based on a notification from the management server;
a service configuration means which performs configuration of an image processing service to be used, according to an input operation; and
a service request transmission unit which transmits to the management server a service request signal corresponding to the configured image processing service and the image data;
a computer constituting the management server to function as:
a storage means which stores an image processing service the service provision device can provide;
a service extraction means which extracts an image processing service available to the service use device;
a service notification means which notifies the service use device of the extracted image processing service;
a service request reception means which receives the service request signal and the image data from the service use device; and
a service execution command transmission means which transmits a service execution command signal corresponding to the service request signal and the image data to a specific service provision device in the computer system; and
a computer constituting the service provision device to function as:
a service execution command reception means which receives the service execution command signal and the image data from the management server; and
an image processing means which applies an image processing corresponding to the service execution command signal on the received image data to output the data.
